(19) United States
(12) Patent Application Publication
(10) Pub. No.: US 2003/0191802 A1
(43) Pub. Date: Oct. 9, 2003

(54) Reshaped UDDI for intranet use

(75) Inventors: Luyin Zhao, Briarcliff Manor, NY (US); Jin Lu, W. Croton-on-Hudson, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/115,181

(22) Filed: Apr. 3, 2002

(51) Int. Cl. G06F 15/16; G06F 7/00

(52) U.S. Cl. 709/203; 707/104.1

(57) ABSTRACT

A method for obtaining service information over an Intranet network is provided. The method includes: making a service request by a service user to a local server operatively connected to the Intranet network; searching a first database operatively connected to the local server for the service request, the first database containing a listing of local service providers available on the Intranet network; and under predetermined circumstances, also searching the Internet for the service request. Preferably, the method also includes informing the service user of the results of the searching. The predetermined circumstances under which the Internet is searched is preferably if the searching of the first database provides no matches to the service request.

### BACKGROUND OF THE INVENTION

1. Field of the Invention

The present invention relates generally to methods and systems for obtaining service information, and more particularly, to obtaining service information using UDDI (Universal Description, Discovery, and Integration) over an Intranet Network (hereinafter simply referred to as “the Intranet”).

2. Prior Art

The rapid and growing adoption of XML technology in the Internet world gives Web services architecture, consisting of Universal Description, Discovery and Integration (UDDI), Simple Object Access Protocol (SOAP), and Web Services Definition Language (WSDL) great potential of being the new generation distributed computing paradigm. Although similar to other existing distributed computing models such as CORBA and DCOM, XML-based Web services possess many advantages including interoperability, light-weighting, firewall-friendliness, etc. Moreover, they are backed by major companies like IBM, Microsoft and Ariba which ensures that it will receive a great deal of attention.

Currently there are home networking protocols known in the art such as UPnP, which is designed to enable simple and robust connectivity among stand-alone devices and PCs from many vendors. However, this protocol only works within the bound of the home environment. Home devices are envisioned to be able to talk to the outside through the Internet.

As discussed above, UDDI is one essential component in the Web services architecture. UDDI itself is becoming a standard in the Internet domain. It has the potential to enable businesses to quickly, easily and dynamically find and transact business with one another using their preferred applications. The UDDI Community is a group of companies actively engaged in developing and deploying the standard.

UDDI has a business registry consisting of three parts:

White Pages provide company contact information,

Yellow Pages categorize business by standard taxonomies, and

Green Pages document the technical information about available services.

To the outside world, UDDI provides two sets of interfaces: one for service registration and one for service discovery. Those entities that wish to make their services available on the Web must register information about themselves and service descriptions using service registration interfaces. These entities are referred to as “Service Providers.” Those entities that need to utilize services available on the Web must use service discovery interfaces to find the desired services from a UDDI registry. They are referred to as “Service Users.”

It is easy to understand UDDI by looking at how it works in the grand scheme of Web services. As shown in FIG. 1, the process starts with a service provider 100 contacting a UDDI registry 102 to register its services. To deal with the heterogeneous nature of the Internet services, WSDL 104 provides a general-purpose XML language for describing service interfaces, protocol bindings, and the deployment details of network services. It is a useful complement to the UDDI standard. Information about a service provider 100 and WSDL description location are saved in the UDDI registry 102. A service user 106 discovers needed services by means of keywords or UDDI browsing. Once a desired service is found, UDDI 102 returns service access Information to the service user 106 so that it can invoke the service provider access point using parameters conforming to the WSDL description. All messaging in this process is accomplished with SOAP 108, which carries implementation-neutral XML-formatted messages.

UDDI is designed for the business and enterprise environment and is accessed over the Internet, while home networking is designed for home use. Although proven useful for their intended purposes, UDDI and home networking suffer from the following problems:

Finding and remembering each other is not easy: First, when a new device is plugged into the home Intranet, it needs to find other devices. For example, a user wants to send the output from a CD player to several speakers in different rooms. The user must enter the service information (including the IP address of a device, descriptions of services provided by the device) of other devices and do the necessary configuration to establish a relationship between the new CD player and these devices. However, this may be a complex task for users with limited computer knowledge. Moreover, it is not easy to determine how the new device should interact with another device (for example what parameters are acceptable in a service request) because devices from different manufacturers may require different parameters in a service request. Second, even if the user is capable of accomplishing the above task, it is still a time-consuming task to enter service information every time the user wants to use other services. Such service information must be stored in client devices and updated every time another new service is added or an existing service is removed.

Home devices don't know how to find services outside home: Sometimes the services that are looked for are not available at home and it is desired to go outside and “service hunt” using the Internet. In addition, due to the limited relevant knowledge typical users have, they want to make this service hunting process transparent to users. For example, when we play an audio CD on a CD player, it is desirable for the CD player to find the lyrics corresponding to the song it is playing and display the lyrics on a TV screen. Because it is unlikely for a CD player to hold the lyrics of every song, the player has to retrieve the lyrics in “real-time.” Typically the lyrics retrieval service is not available within the home. The Internet becomes the only source for this kind of services.

It is hard to access home devices from the outside: People want to access home facilities when they are in a remote location, such as in the office or on the road. For example, you may want to turn on the air conditioner at home before you leave the office. This can be accomplished with home services. A more advanced usage of home services is called command and control, which consists of sensing, fusing and actuating Web services. In these situations, the only way to access the home services is to use the office workstation, a wireless computer or a PDA. Since home service information usually is not stored in an office computer (or it is not safe to do so), the service may not be invoked from an office computer.

### SUMMARY OF THE INVENTION

In light of these problems, what is needed is an intermediary to facilitate communication among devices within a home Intranet network and with the Internet. As mentioned above, some existing home networking protocols such as UPnP are designed to solve the first problem, i.e. the discovery and invocation of in-home services. However, they lack the capability to handle service discovery and invocation of services crossing the home boundary as is required to solve the other two problems.

Therefore it is an object of the present invention to provide a method and system for obtaining service information over both the Intranet and Internet using UDDI.

Accordingly, a method for obtaining service information over an Intranet network is provided. The method comprising: making a service request by a service user to a local server operatively connected to the Intranet network; searching a first database operatively connected to the local server for the service request, the first database containing a listing of local service providers available on the Intranet network; and under predetermined circumstances, also searching the Internet for the service request. Preferably, the predetermined circumstances under which the Internet is searched is if the searching of the first database provides no matches to the service request. Preferably, the method further comprises informing the service user of the results of the searching.

The method preferably further comprises: storing a listing of at least a portion of service providers available on the Internet in a second database operatively connected to the local server; and under predetermined conditions and prior to searching the Internet for the service request, searching the second database for the service request. Preferably, the predetermined circumstances under which the second database is searched is if the searching of the first database provides no matches to the service request.

The method preferably further comprises: selecting, by the service user, at least one of the results of the search; and returning an indication of the selection of the at least one of the results to a corresponding service provider. The returning preferably comprises returning the indication to a router, which in turn returns the indication to the corresponding service provider. The method preferably further comprises forwarding information regarding the selected at least one of the results back to the service user from the corresponding service provider. Preferably, the forwarding comprises forwarding the information to a router, which in turn forwards the information to the service user. Alternatively, the method further comprises forwarding information regarding the selected at least one of the results from the corresponding service provider to another service provider on the Intranet network.

Also provided is a system for obtaining service information over an Intranet network. The system comprises: a local server operatively connected to the Intranet network; a first database operatively connected to the local server, the first database containing a listing of local service providers available on the Intranet network; means for searching the first database for the service request; a communications connection operatively connecting the Intranet network to the Internet; and means for searching the Internet for the service request under predetermined circumstances. The system preferably further comprises a display for displaying results of the search to the service user.

Preferably, the system further comprises a second database operatively connected to the Intranet network for storing a listing of at least a portion of service providers available on the Internet, wherein the second database is searched for the service request prior to the Internet being searched for the service request.

The system preferably further comprises selecting means for selecting at least one of the results of the Internet search, wherein the communication connection returns an indication of the selection of the at least one of the results to a corresponding service provider. In which case, the system preferably further comprises a router, wherein the indication is sent to the corresponding service provider via the router. Preferably, the communication connection further forwards information regarding the selected at least one of the results back to the service user from the corresponding service provider. In which case, the system further comprises a router, wherein the information is forwarded to the service user via the router.

Preferably, the system further comprises a wrapper operatively connected to the local server for forwarding the service request to the local server, receiving a reply therefrom, and informing the service user of the results of the search. The wrapper is also preferably operatively connected to the local server and the Internet for forwarding the service request to the Internet, receiving a reply therefrom, and informing the service user of the results of the Internet search. Still also preferable is if the wrapper is operatively connected to the local server and the second database for forwarding the service request to the second database, receiving a reply therefrom, and informing the service user of the results of the second database search.

Preferably, the communication connection further forwards information regarding the selected at least one of the results from the corresponding service provider to another service provider on the Intranet network.

Still further provided is a method for obtaining service information from an Intranet network. The method comprising: making a service request by a service user from an Internet to a local server operatively connected to the Intranet network; and searching a first database operatively connected to the local server for the service request, the first database containing a listing of local service providers available on the Intranet network.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a schematic of a UDDI based web service model of the prior art.

FIG. 2 illustrates a schematic of an example of a basic home networking environment according to the present invention.

FIG. 3 illustrates a flowchart of a preferred implementation of the methods of the present invention.

FIG. 4 illustrates flowchart branch A of the flowchart of FIG. 1.

FIG. 5 illustrates a schematic of a preferred system of the present invention for practicing the methods of FIGS. 1 and 2.

FIG. 6 illustrates a UML (Unified Modeling Language) sequence diagram for a first example of the preferred methods of the present invention.

FIG. 7 illustrates a UML (Unified Modeling Language) sequence diagram for a second example of the preferred methods of the present invention.

FIG. 8 illustrates a UML (Unified Modeling Language) sequence diagram for a third example of the preferred methods of the present invention.

FIG. 9 illustrates a UML (Unified Modeling Language) sequence diagram for a fourth example of the preferred methods of the present invention.

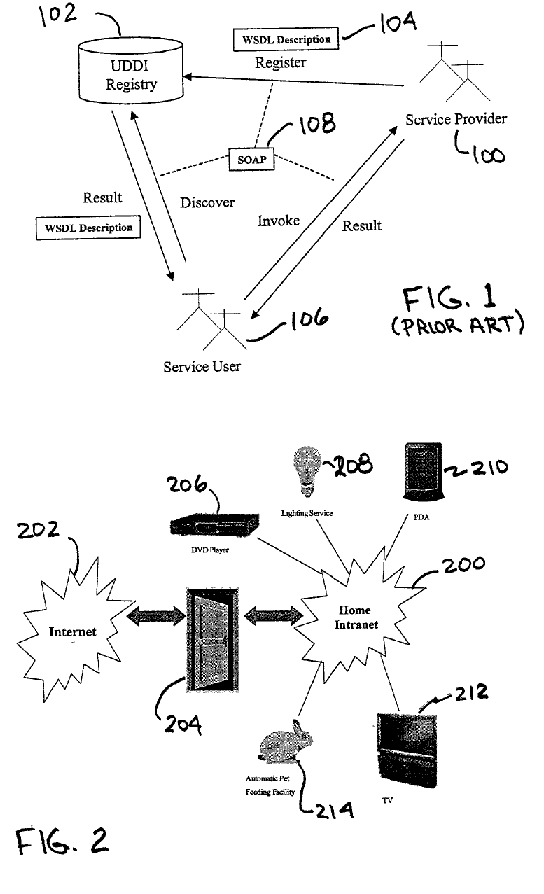

### DETAILED DESCRIPTION OF THE PREFERRED EMBODIMENT

Although this invention is applicable to numerous and various types of Intranet networks, it has been found particularly useful in the environment of home networking. Therefore, without limiting the applicability of the invention to home networking, the invention will be described in such environment.

A home networking environment can be viewed as an Intranet connecting various home devices. Home devices can be categorized into three groups according to their primary usage:

Entertainment appliances. This group includes TV, VCR, DVD player, etc. The primary usage of these appliances is to receive and display video streaming and audio (collectively referred to as “content”).

Data oriented devices. This group of devices includes PCs and handheld devices. The primary usage of these devices is to receive and process data, although some may be consumed as streams.

Data acquisition and control devices. This group of devices includes home security systems, cameras, sensors, and actuators for home automation and home healthcare. Their primary usage is to gather data, generate alert/alarm signals, and send commands to turn on/off home appliances.

For purposes of this disclosure, the home devices are considered service providers analogous to the service providers discussed above with regard to UDDI in that they all provide a service to a service user. For instance, a TV, VCR, and DVD player provides the service of receiving and displaying content to the service user, and in the case of the VCR, of copying the received content. Similarly, data acquisition and control devices provide the service of home security. However, some devices may also be considered a “service user” such as a television which requests a service from a DVD player (e.g., to display a movie thereon).

The main purpose of connecting these devices is to let them interact with one another through a home network, and potentially with services outside the home through a home gateway, which routes data between access networks and home networks. A natural concern for accomplishing this goal is how these different devices, possibly from various vendors can inter-operate with each other and even communicate with services on the Internet.

FIG. 2 shows a typical home networking environment with various devices 206-214 that at least provide services (i.e., act as a service provider) and may also request services (i.e., act as a service user). The communication between a home Intranet 200 and the Internet 202 through portal 204 is ideally two-way. This allows a user to utilize public services from the Internet 202 when he or she is at home and control home devices 206-214 when he or she is at a remote location, such as on the road or at the office. Examples of the home devices include a DVD player 206, a lighting service 208, a personal digital assistant (PDA) 210, a television 212, and an automatic pet feeding facility 214. The use of such devices 206-214 is well known in the art.

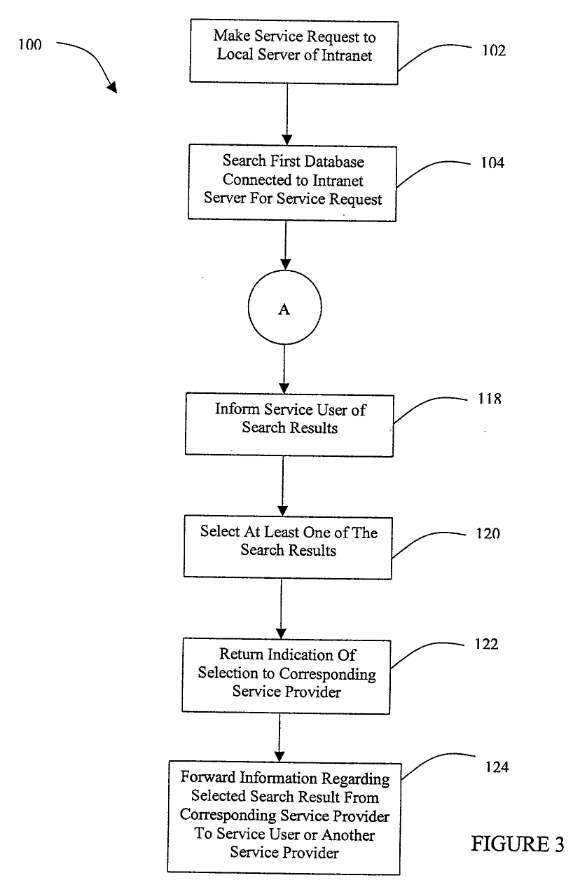

Referring now to FIGS. 3, 4, and 5 in combination, there is illustrated a flowchart and schematic of a preferred implementation of a method and system for obtaining service information over an Intranet network 200, such as a home networking environment, the configuration and operation of which are well known in the art. The term “obtaining service information” is used in a general sense to mean not only obtaining information regarding services, as is discussed in Example 1 below, but to control home devices, as is discussed in the remaining Examples below. The method is generally referred to by reference numeral 100.

At step 102, a service request by a service user is made to a local server 300 operatively connected to the Intranet network, which is preferably a home networking environment, but may also be a business Intranet. The local server 300 has a local or internal UDDI (and is alternatively referred to as such). A first database 302 operatively connected to the local server 300 is searched at step 104 for the service request. The first database 302 contains a listing of local service providers available on the Intranet network 200.

Within the home Intranet 200, there are services intended for internal use because most of the devices 206-214, if not all, are private. In order to use these services, a local UDDI registry must be set up for use within the Intranet. In other words, all internal services are registered and discovered from this local UDDI registry and stored in the first database 302. The local UDDI registry should be compatible with an external or public UDDI registry 310 on the Internet 202 such as those from IBM and Microsoft in order to be able to request global services and receive requests from outside the intranet network 200. The local registry should also be an agent/proxy/filter that delegates or relays requests targeted to the public UDDI 310. That is, service users inside the Intranet network 200 can also send a request to external services on the Internet 202 such as an office desktop 312, a sports Star Finder Service 314, a map service 316, and flight track services from competing airlines 318, 320. In this situation, service users request external services the same way they do to request local ones. Hence the local UDDI registry, as a proxy or agent, forwards requests to the public UDDI 310 or rejects such requests (in case of parental control, for example), receive responses from the public UDDI 310 and relays them back to the service user who makes the request. A service user on the Intranet network 200 may or may not be aware that some services actually come from outside the Intranet network 200. Also, the local UDDI 300 can modify the “look and feel” of an Internet service to comply with that of local services.

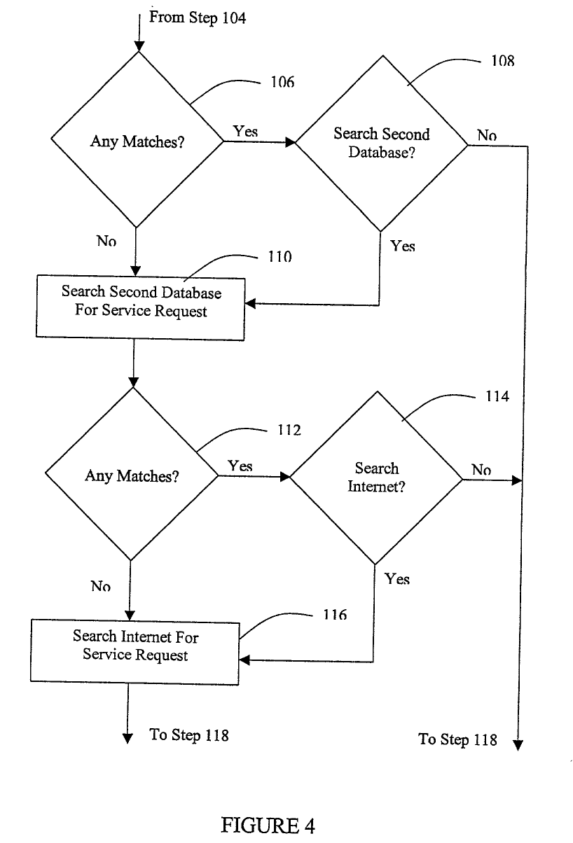

Under predetermined circumstances, the Internet 202 is also searched for the service request. The predetermined circumstances are discussed below with regard to portion A of FIG. 3 and shown in detail in FIG. 4. At step 118, the service user is informed of the results of the search, if necessary, preferably by displaying the results of the search.

At step 120, the service user selects at least one of the results of the search. If such results are displayed, for instance on a computer monitor, the user selects the results by any means known in the art such as by mouse clicking on one of the results from a list of the results. At step 122, an indication of the selection of the results is returned to a corresponding service provider. Preferably, the indication is first returned to a router 304 which in turn returns the indication to the corresponding service provider. The router 304 is preferred to relay all service requests and responses between the Internet 202 and the Intranet 200 transparently. Therefore, a service request is sent to the router 304 first. The router 304 checks a message header (URL) and determines if the request is targeted at the Internet 202 or the Intranet network 200, and forwards the request accordingly. When the result comes back, the router 304 forwards it back to the service user or to a service provider on the Internet network 200. The router 304 can have a list of services that need to be blocked or refused authorization. Another function of the router 304 is to perform authentication when service requests come from the Internet 202 into the Intranet network 200.

At step 124, information regarding the selected results are forwarded back to the service user from the corresponding service provider. The information is preferably first forwarded to the router 304 which in turn forwards the information to the service user. Alternatively, information regarding the selected results is forwarded from the corresponding service provider to another service provider (acting as a service user) on the Intranet network 200.

For better performance, the local UDDI 300 may also ‘cache’, certain service descriptions in a second database 306 from a public UDDI 310 so that some inquires to the public UDDI 310 may be expedited by checking the cache. The second database 306 (alternately referred to as a “cache”) is attached to the local UDDI 300 and preferably has the same data structure as the public UDDI 310, but has limited storage space containing a subset of the most frequently used service descriptions from the public UDDI 310. Algorithms to refresh/update cache (second database) based on recent service requests are quite mature in the art (for example, caching in operating systems). Referring now to FIG. 4, at step 106, it is determined whether any matches to the service request where found in the first database 302. If yes (106-yes), it is determined if the second database 306 is to be searched for the service request. The second database 306 is operatively connected to the local server 300.

Under predetermined conditions and prior to searching the Internet 202 for the service request, the second database 306 is searched for the service request. Preferably, the predetermined circumstances under which the second database 306 is searched is if the searching of the first database 302 provides no matches to the service request, shown schematically at step 106-No. However, even if the search of the first database 302 results in matches to the service request shown schematically as step 108-yes, the second database 306 can be searched. For instance, the second database 306 can be searched if less than a predetermined number of search results are returned from the search of the first database 302. If searching of the second database is desired, it is done so at step 110. If not, the method proceeds along path 108-no to step 118 where the service user is informed of the results, if necessary.

After searching of the second database 306, if desired, it is determined if the searches of the first and second databases 302, 306 produced any matches at step 112. If yes (112-yes), it is further determined if the Internet 202 should be searched for the service request at step 114. If not, the method proceeds to step 118 where the service user is informed of the results. If no results have been produced from the search of the first and second databases (112-No) or results have been produced and it is desired to search the Internet 202 nonetheless (114-yes), the method proceeds to step 116 where the Internet 202 is searched for the service request. Thus, as can be seen by the preferred implementation of the method of FIGS. 3 and 4, the predetermined circumstances under which the Internet 202 is searched is if the searching of at least the first database and preferably also the second database provides no matches to the service request. Those skilled in the art will appreciate that other predetermined circumstances are possible, such as searching the Internet 202 for the service request where the searches of the first and/or second databases 302, 306 produce less than a predetermined number of results.

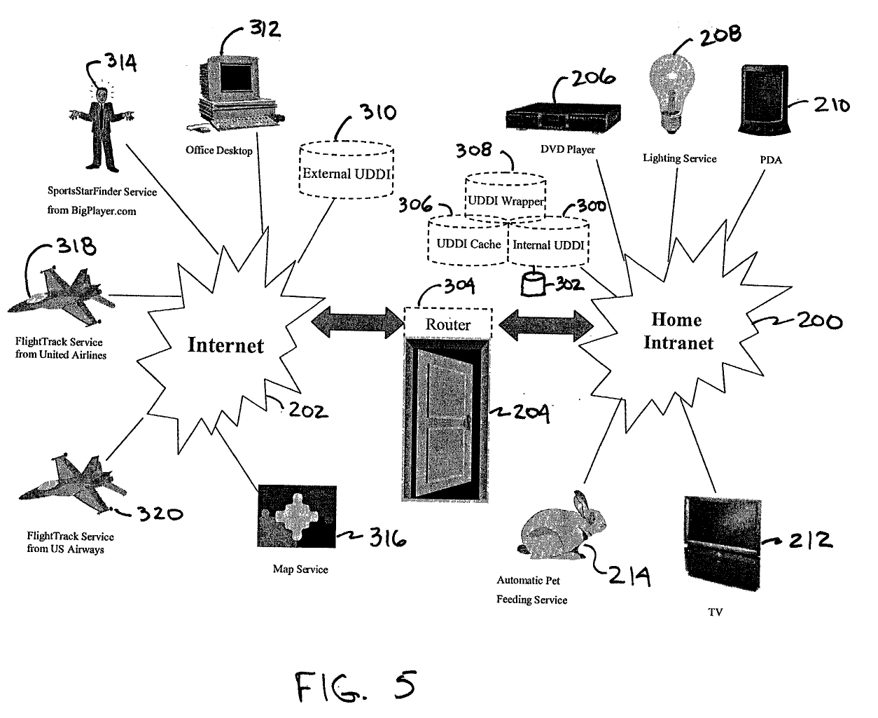

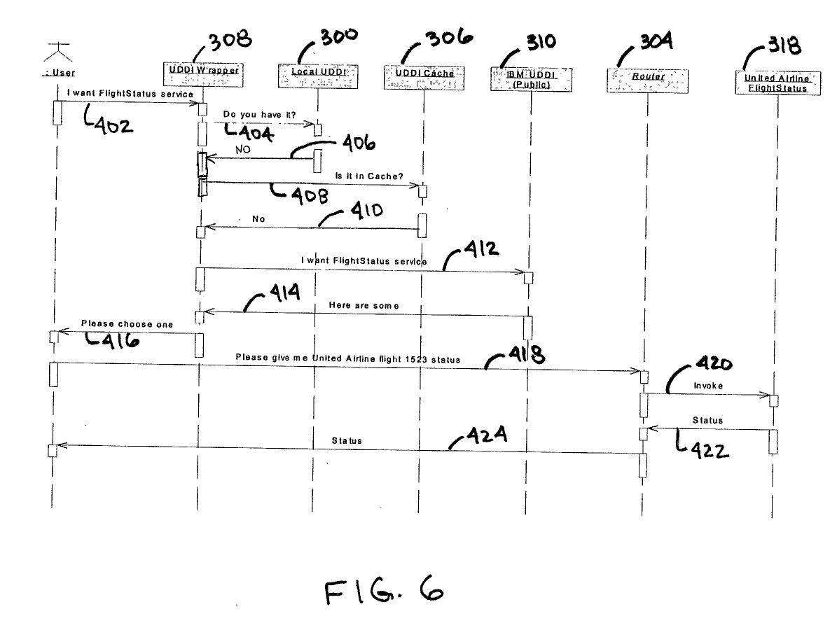

Referring back to FIG. 5, the system also preferably includes a UDDI wrapper 308. The UDDI wrapper 308 (alternatively referred to as a “service locator”) is configured on top of the local UDDI 300 and provides the same set of APIs as the local UDDI 300. Users are preferably required to send a request to the UDDI wrapper 308 rather than accessing the local UDDI 300 directly. Once a user sends a request to a wrapper API, the UDDI wrapper 308 forwards the request to the local UDDI 300. If the response shows that the service description is in the local UDDI 300, the UDDI wrapper 308 returns this information to the service user who makes the service request. Otherwise, under the predetermined conditions, the UDDI wrapper 308 contacts the public UDDI 310 and returns whatever information it receives. This process is preferably transparent to the service user. Thus, the UDDI wrapper 308 is operatively connected to the local server 300 for forwarding the service request to the local server 300, receiving a reply therefrom, and informing the service user of the results of the search. The UDDI wrapper 308 is also preferably operatively connected to the Internet 202 for forwarding the service request to the Internet 202, receiving a reply therefrom, and informing the service user of the results of the Internet search. Still further, the wrapper is also preferably operatively connected to the external or second database 306 for forwarding the service request to the external database 306, receiving a reply therefrom, and informing the service user of the results of the external database search.

As will be discussed more fully below by way of the Examples, the communication connection can also forward information regarding the selected results from the corresponding service provider to another service provider on the Intranet network 200. Thus, the service request can be to the DVD player 206 to play a particular movie on a particular television 212 on the home networking environment 200. In which case, the DVD content (the information) is forwarded from the DVD player (service provider) to the Television 212 (another service provider). Of course, information may also be sent to the service user, such as a conformation that the service request has been received and has been or will be fulfilled.

### EXAMPLES

The preferred method and system of the present invention will now be described by way of several Examples. Those skilled in the art will appreciate that the same are given by way of example only and not to limit the scope or spirit of the present invention in any way.

### Example 1

A first example will now be described with reference to FIG. 6. The service user begins by accessing the UDDI wrapper 308 to request a Flight Status service at 402. The UDDI wrapper 308 requests the service from the local UDDI 300 at 404. The local UDDI tries to find it locally, but cannot and responds to the UDDI wrapper with a “no” at 406. The UDDI wrapper then looks for it at cache 306 at 408. The requested service is not in the cache 306 and the cache 306 responds to the UDDI wrapper with a “no” at 410. The UDDI wrapper then requests the service from the public UDDI 310 at 412, which returns a list of similar services to the UDDI wrapper 308 at 414. The UDDI wrapper 308 returns the list to the service user at 416. The service user then chooses the United Airline Flight status tracker service 318 and communicates the request to it at 418 through the router 304 at 420. The United Airlines Flight status tracker service 318 then forwards the result to the router 304 at 422, which forwards the result back to the service user at 424.

### Example 2

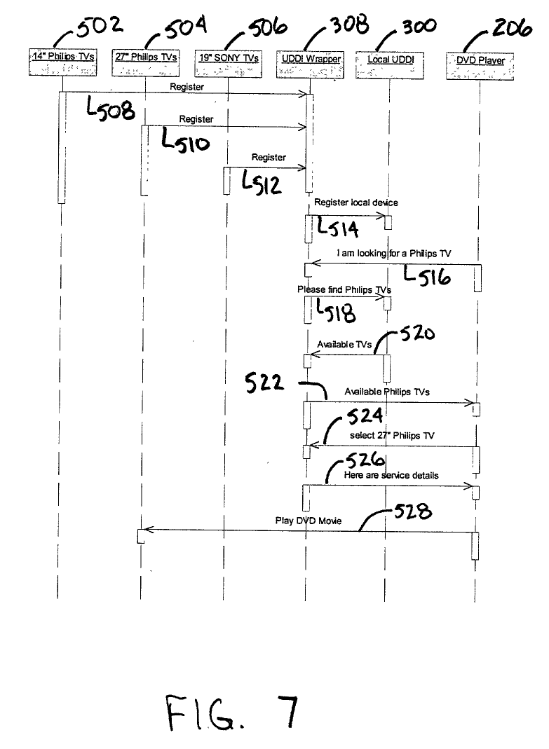

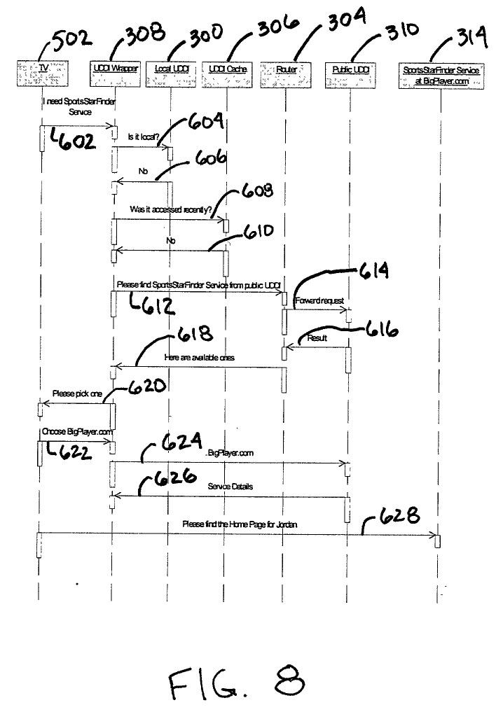

A second example will now be described with reference to FIG. 7. In the second example, a television 502, 504, 506 is considered as both a service provider that provides the service of displaying a video on a screen and as a service user which requests content from a DVD player be displayed thereon. We assume there are multiple televisions 502-506 (a 14″ Philips 502, a 27″ Philips, and a 19″ Sony) in a home having the system illustrated in FIG. 5. A DVD player 206 is a typical service provider that requires an output device to display what it plays, no matter whether the output device is a computer or a TV. For purposes of this example, it is assumed that the output of a DVD player is operatively connected to all televisions 502-506 and can therefore be sent to any of the televisions 502-506 in the home.

Since televisions 502-506 are service providers, they are required to register themselves with the local UDDI 300 first. This is referred to as a service description process and is preferably done automatically by the televisions 502-506. There are at least three options on how to find the local UDDI 300 the first time the service providers are connected to the home network 200. They are:

The new device broadcasts its presence to the home network 200; once the local UDDI server 300 hears this message, it responds with its address.

The local UDDI server 300 broadcasts its address information regularly so that any new device connected thereto can receive it (with some delay).

The local UDDI server 300 has a fixed and well-known address.

After finding the local UDDI server 300, new televisions and other devices can register themselves into the UDDI registry using standard APIs. Registration information can include such information as model number, manufacturer, IP address, access methods, parameters, etc.

As mentioned above, it is impractical for normal users with little technical expertise to configure a device such as the DVD player 206 with information such as the IP addresses of televisions in order to initialize communication with them. Therefore, it is preferred that the DVD player 206 and other such devices consult the UDDI registry and discover possible TVs and how to invoke them in terms of methods and parameters. The discovery process is similar to the normal business-service discovery process of UDDI.

In summary, the televisions 502-506 connected on the home network 200 register with the UDDI wrapper 308 at 508, 510 and 512. The UDDI wrapper registers the DVD player with the local UDDI server 300 at 514. After a request is made by the service user to play DVD content on a television, the DVD player contacts the UDDI wrapper 308 looking for a television at 516. The UDDI wrapper 308 contacts the local UDDI server 300 looking for televisions registered therewith at 518. The local UDDI server 300 returns information to the UDDI wrapper 308 indicating the available televisions at 520. The UDDI wrapper 308 then returns the information to the DVD player 206 at 522 which may be more specific, such as what are the available televisions of a certain manufacturer or size. The DVD player 206 then selects one of the televisions 504 from the supplied list at 524 and the UDDI wrapper 308 returns service information for the selected television 504, such as its address on the home network 200 to the DVD player 206 at 526. The DVD player 206 then contacts the selected television 504 and plays the selected content thereon.

### Example 3

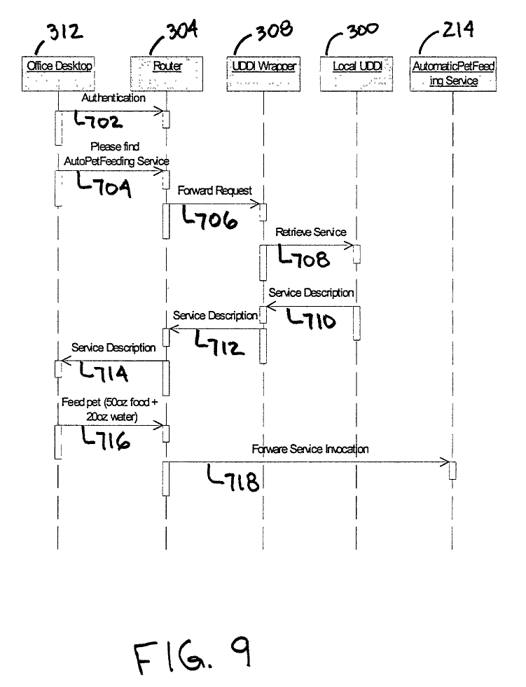

A third example will now be described with reference to FIG. 8. Although, the second example may be the most typical scenario in a home Intranet 200 (i.e., both the service provider and the service users are located within the home) however, sometimes service users are not able to find what they need at home. For example, if the service user is watching a very interesting football game. He or she may think a new football player did a terrific job and wants to know more about him. Therefore, since this type of service is not likely to be found on the home network 200, it is necessary to go outside the home network 200 and search for a possible ‘sports star home page finder’ service.

To the service user, this process should be transparent. That is, once a service user sends such a service discovery request, the UDDI wrapper 308 is responsible for finding this service, no matter if it is local to the home network 200 or external on the Internet 202.

As shown in FIG. 8, the UDDI wrapper 308 receives a service request at 602 (for a Sports Star Finder service) from the client (in this example, the television 502 operated by the service user). The UDDI wrapper 308 first looks at the local UDDI server 300 at 604 to see if there is a match. If not (606), the UDDI wrapper 308 searches the UDDI cache (second database 306) at 608 to see if this service is frequently used and the information is already cached. If still not found (610), the UDDI wrapper 308 automatically contacts a public UDDI 310 at 612, preferably through the router 304 at 614 and looks for the requested service. The results (access point and methods descriptions) are returned to the client 502 at 620, preferably via the router 304 at 616 and the UDDI wrapper 308 at 618. The client 502 selects one of the results at 622 and communicates the same to the UDDI wrapper 308, which in turn contacts the selected service at 624 and receives the results therefrom from the service at 626. The client 502 is then able to send service requests to the service provider 314 without knowing where the service provider is located (e.g., internal to the home network 200 or external on the Internet 202).

### Example 4

A fourth example will now be described with reference to FIG. 9. In general, home services on a home network 200 are not (directly) available to external entities partly because of security concerns. However, sometimes the owner of a house may need to access home services on his or her home network 200 because he is on the road or in the office and there may be an urgent need to access a home device on the home network 200. For example, Tom has a pet that needs to be fed every day at noon. But Tom is working at his office at this time. Therefore, Tom wants to feed his pet from his office desktop computer.

Tom first contacts his home UDDI 200 from his office desktop 312 through the home router 304 at 702 for the Automatic Pet Feeding service 214. After authentication with the router 304, Tom is able to send his request to the UDDI wrapper 308 at 704 and 706. The UDDI wrapper 308 retrieves the service description from the local UDDI 300 at 708 and returns it back to Tom through the UDDI wrapper 308 at 710, the router 304 at 712 and to his desktop 312 at 714. Tom then makes an invocation to the automatic Pet Feeding service 214 at 718 with parameters of 50 oz bunny food and 20 oz water through the router 304 at 716.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for obtaining service information over an Intranet network, the method comprising:
making a service request by a service user to a local server operatively connected to the Intranet network;
searching a first database operatively connected to the local server for the service request, the first database containing a listing of local service providers available on the Intranet network; and
under predetermined circumstances, also searching the Internet for the service request.

2. The method of claim 1, further comprising informing the service user of the results of the searching.

3. The method of claim 1, further comprising:
storing a listing of at least a portion of service providers available on the Internet in a second database operatively connected to the local server; and
under predetermined conditions and prior to searching the Internet for the service request, searching the second database for the service request.

4. The method of claim 3, wherein the predetermined circumstances under which the second database is searched is if the searching of the first database provides no matches to the service request.

5. The method of claim 1, wherein the predetermined circumstances under which the Internet is searched is if the searching of the first database provides no matches to the service request.

6. The method of claim 1, further comprising:
selecting, by the service user, at least one of the results of the search; and
returning an indication of the selection of the at least one of the results to a corresponding service provider.

7. The method of claim 6, wherein the returning comprises returning the indication to a router which in turn returns the indication to the corresponding service provider.

8. The method of claim 6, further comprising forwarding information regarding the selected at least one of the results back to the service user from the corresponding service provider.

9. The method of claim 8, wherein the forwarding comprises forwarding the information to a router which in turn forwards the information to the service user.

10. The method of claim 6, further comprising forwarding information regarding the selected at least one of the results from the corresponding service provider to another service provider on the Intranet network.

11. A system for obtaining service information over an Intranet network, the system comprising:
a local server operatively connected to the Intranet network;
a first database operatively connected to the local server, the first database containing a listing of local service providers available on the Intranet network;
means for searching the first database for the service request;
a communications connection operatively connecting the Intranet network to the Internet; and
means for searching the Internet for the service request under predetermined circumstances.

12. The system of claim 11, further comprising a display for displaying results of the search to the service user.

13. The system of claim 11, further comprising a second database operatively connected to the Intranet network for storing a listing of at least a portion of service providers available on the Internet, wherein the second database is searched for the service request prior to the Internet being searched for the service request.

14. The system of claim 11, further comprising selecting means for selecting at least one of the results of the Internet search, wherein the communication connection returns an indication of the selection of the at least one of the results to a corresponding service provider.

15. The system of claim 14, further comprising a router, wherein the indication is sent to the corresponding service provider via the router.

16. The system of claim 14, wherein the communication connection further forwards information regarding the selected at least one of the results back to the service user from the corresponding service provider.

17. The system of claim 16, further comprising a router, wherein the information is forwarded to the service user via the router.

18. The system of claim 11, further comprising a wrapper operatively connected to the local server for forwarding the service request to the local server, receiving a reply therefrom, and informing the service user of the results of the search.

19. The system of claim 11, further comprising a wrapper operatively connected to the local server and the Internet for forwarding the service request to the Internet, receiving a reply therefrom, and informing the service user of the results of the Internet search.

20. The system of claim 13, further comprising a wrapper operatively connected to the local server and the second database for forwarding the service request to the second database, receiving a reply therefrom, and informing the service user of the results of the second database search.

21. The system of claim 14, wherein the communication connection further forwards information regarding the selected at least one of the results from the corresponding service provider to another service provider on the Intranet network.

22. A method for obtaining service information from an Intranet network, the method comprising:
making a service request by a service user from the Internet to a local server operatively connected to the Intranet network; and
searching a first database operatively connected to the local server for the service request, the first database containing a listing of local service providers available on the Intranet network.
